(19) United States
(12) Patent Application Publication
(10) Pub. No.: US 2002/0061420 A1
(43) Pub. Date: May 23, 2002

(54) Electroluminescent polymer having fluorene pendant and electroluminescent device using the same

(75) Inventors: Byung Hee Sohn, Daejun-Shi (KR); Kwang Yeon Lee, Daejun-Shi (KR)

Correspondence Address: THE LAW OFFICES OF EUGENE M. LEE, PLLC, 1101 WILSON BOULEVARD, SUITE 2000, ARLINGTON, VA, 22209, US

(73) Assignee: Samsung SDI Co., Ltd.

(21) Appl. No.: 09/986,135

(22) Filed: Nov. 7, 2001

(30) Foreign Application Priority Data
Nov. 7, 2000 (KR) 2000-65864

(51) Int. Cl. H05B 33/14; C09K 11/06; C08G 61/02

(52) U.S. Cl. 428/690; 428/917; 313/504; 313/506; 252/301.35; 257/40; 257/103; 526/280; 526/296; 528/397

(57) ABSTRACT

An electroluminescent polymer represented by the following formula (1):

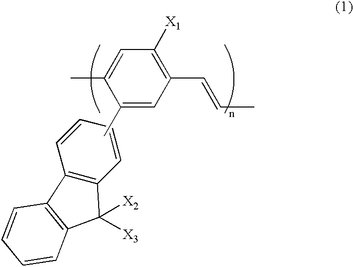

wherein

X₁ is a linear alkyl or alkoxy group having 1 to 40 carbon atoms, a branched alkyl or alkoxy group having 3 to 40 carbon atoms, a cyclic alkyl group having 5 to 40 carbon atoms, or a silyl group substituted with at least one alkyl group having 1 to 40 carbon atoms, and

X₂ and X₃ are independently a hydrogen atom, a linear alkyl or alkoxy group having 1 to 40 carbon atoms, a branched alkyl or alkoxy group having 3 to 40 carbon atoms, a cyclic alkyl group having 5 to 40 carbon atoms, an aromatic group having 6 to 14 carbon atoms which is unsubstituted or substituted with at least one selected from the group consisting of an alkoxy group having 1 to 40 carbon atoms and an amine group, a silyl group substituted with at least one alkyl group having 1 to 40 carbon atoms, or −{(CH₂)ₓO}_{y}CH₃ wherein x is an integer from 1 to 10 and y is an integer from 1 to 10.

### BACKGROUND OF THE INVENTION

1. Field of the Invention

The present invention relates, in general, to an electroluminescent polymer and an electroluminescent device using the same. More specifically, the present invention pertains to an electroluminescent polymer comprising a main chain of phenylene vinylene and a side chain of fluorene and an aliphatic alkyl or alkoxy group, which is advantageous in terms of increased luminous efficiency, and an electroluminescent device fabricated with the electroluminescent polymer.

2. Description of the Prior Art

With great advances in the field of electronics made possible by the use of silicon as a semiconductor material, people have enjoyed various modern conveniences. Recently, the rapid growth in the optical communication and multi-media fields has accelerated the development of information communities. Consequently, optoelectronic devices that convert light energy into electric energy and vice versa are very important in the electronic information industry nowadays. Such semiconductive optoelectronic devices can be classified as electroluminescent devices, semiconductive laser devices, light-receiving type devices, etc.

A flat panel display generally means a device that solves inherent difficulties in picture processing by the conventional CRT (cathode ray tube) mode, and a device that expresses images of at least the same quality as that of the CRT mode. The earlier display was mostly used for wall-mounted monitors.

It has been applied to computer monitors, notebook PC's, PDA terminals, etc., for modern information technology and multi-media devices. Most of the display means are of the light-receiving type, whereas an electroluminescent (EL) display is of the magnetic-light-emitting type. The EL display has advantages including fast response, obviation of backlighting effect, and excellent luminance, so that many applications therefore are under study. Such EL devices are fabricated with inorganic semiconductors using GaN, ZnS and SiC, and thus are used as practical displays. In the case of EL devices prepared from an inorganic material, as the driving voltage is over 200 V and the manufacture of the EL device is carried out by means of a vacuum deposition process, a large size device cannot be prepared and the cost of preparation is very high.

However, Eastman Kodak Company presented a device prepared with a pigment having a π-electron conjugated structure, called “alumina-quinone, Alq.sub.3” in 1987, and thereafter research into EL devices using organic material has been active. In case of using an organic material having low molecular weight, a synthesis procedure is simple, it is easy to synthesize materials in various forms, and color tuning is possible. However, such materials have disadvantages including low mechanical strength and low crystallization upon heat exposure. To overcome the above disadvantages, research is being conducted to develop an organic EL device having a polymeric structure. In the π-electron conjugated polymer, the energy level is split into a conduction band and a valence band by the overlap of πelectron wave functions which exists in the polymer main chain, various semiconductive properties of polymer are decided by a band gap energy which corresponds for the energy difference between the conduction band and the valence band, and a processing of full color is possible. Such a polymer is referred to as a “π-electron conjugated polymer”. Research to develop electroluminescent polymers has been carried out in Cambridge University, England, 1990, producing poly(p-phenylene vinylene) (hereinafter, “PPV”), a polymer having conjugated double bonds, and thereafter attempts have been made to apply π-electron conjugated polymer to an electroluminescent display.

As a representative polymer for application to organic electroluminescent devices, use is made of a poly(p-phenylene vinylene)(PPV) derivative, which is π-electron conjugated polymer. But a poly(p-phenylene vinylene) derivative typically has the drawbacks of poor reproducibility of polymer synthesis procedure, and mass production limits due to difficulty in purification of the polymer, low solubility in organic solvents, long polymerization time and low polymerization yield. It is also typically disadvantageous due to very high glass transition temperature and high molecular weights required for overcoming Joule heat generated upon driving the EL device, and low luminous efficiency and green purity.

### SUMMARY OF THE INVENTION

It is a feature of the present invention to provide an electroluminescent polymer, with few or no heteronuclear atoms besides carbon and hydrogen, comprising a main chain of PPV and a side chain of fluorene and an aliphatic alkyl group, aliphatic alkoxy group or silicon group, which is advantageous in terms of high solubility in organic solvents and increased luminous efficiency.

It is another feature of the present invention to provide a copolymer comprising a monomer of the above electroluminescent polymer and a PPV-based monomer.

It is a further feature of the present invention to provide a composition comprising a mixture of the above electroluminescent polymer and a PPV-based polymer.

It is a still further feature of the present invention to provide an electroluminescent device using the electroluminescent polymer.

In accordance with one aspect of the present invention, there is provided an electroluminescent polymer, represented by the following formula (1):

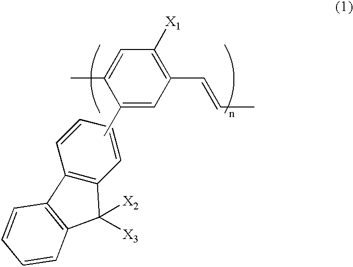

wherein X₁ is a linear alkyl or alkoxy group having 1 to 40 carbon atoms, a branched alkyl or alkoxy group having 3 to 40 carbon atoms, a cyclic alkyl group having 5 to 40 carbon atoms, or a silyl group substituted with at least one alkyl group having 1 to 40 carbon atoms, and X₂ and X₃ are independently a hydrogen atom, a linear alkyl or alkoxy group having 1 to 40 carbon atoms, a branched alkyl or alkoxy group having 3 to 40 carbon atoms, a cyclic alkyl group having 5 to 40 carbon atoms, an aromatic group having 6 to 14 carbon atoms which is unsubstituted or substituted with at least one selected from the group consisting of an alkoxy group having 1 to 40 carbon atoms and an amine group, a silyl group substituted with at least one alkyl group having 1 to 40 carbon atoms, or —{(CH₂)ₓO}_{y}CH₃ wherein x is an integer from 1 to 10 and y is an integer from 1 to 10. Examples of the cyclic aliphatic group include cyclohexyl group, admantyl group, etc. Examples of the silyl group include trimethylsilyl group, dimethyloctylsilyl group, etc. Examples of the aromatic group phenyl group, naphthyl group, etc.

In accordance with another aspect of the present invention, there is provided an electroluminescent polymer, comprising a monomer of the above electroluminescent polymer and a PPV-based monomer, represented by the following formula (3):

[chemical structure]

wherein X₁, X₂ and X₃ are defined as in the above formula (1), X₄ and X₅ are independently a linear aliphatic alkoxy group having 1 to 40 carbon atoms, a branched aliphatic alkoxy group having 3 to 40 carbon atoms, or a cyclic aliphatic alkoxy group having 5 to 40 carbon atoms, and a and b are numbers such that 0.1≲a/(a+b)≲0.9.

In accordance with a further aspect of the present invention, there is provided an electroluminescent polymer composition wherein the above electroluminescent polymer and a PPV-based polymer are mixed in the weight ratio of between about 1:99 to about 99: 1, more preferably between about 5:95 to 95:5.

In accordance with a still further aspect of the present invention, there is provided an electroluminescent device comprising one structure selected from the group consisting of an anode/light emitting layer/cathode, an anode/buffer layer/light emitting layer/cathode, an anode/buffer layer/hole transport layer/light emitting layer/cathode, an anode/buffer layer/hole transport layer/light emitting layer/electron transport layer/cathode, and an anode/buffer layer/hole transport layer/light emitting layer/hole blocking layer/cathode, wherein the above electroluminescent polymer or the above electroluminescent polymer composition is contained in the light emitting layer.

### BRIEF DESCRIPTION OF THE DRAWINGS

The above and other features and other advantages of the present invention will be more clearly understood from the following detailed description taken in conjunction with the accompanying drawings, in which:

FIG. 1a is a reaction scheme illustrating the preparation of poly[2-(9′,9″-dihexylfluorene-2′-yl)-1 ,4-phenylene vinylene] (DHF-PPV), as in preparation example 1.

FIG. 1b is a reaction scheme illustrating the preparation of poly[2-methoxy-5-(9′,9″-dioctylfluorene-2′-yl)-1,4-phenylene vinylene] (MDOF-PPV), as in preparation example 4.

FIG. 2a is the ¹H-NMR spectrum of DHF-PPV, as prepared in preparation example 1.

FIG. 2b is the ¹H-NMR spectrum of MDOF-PPV, as prepared in preparation example 4.

FIG. 3a shows the UV-Vis spectrum and photoluminescence spectrum of DHF-PPV as prepared in preparation example 1.

FIG. 3b is the electroluminescence spectrum of DHF-PPV as prepared in preparation example 1.

FIG. 4a shows the TGA thermograms of DHF-PPV, DHF-PPV/MEH-PPV copolymer (1:1), DHF-PPV/MEH-PPV copolymer (10:1) and MEH-PPV, as prepared in preparation examples 1-3 and comparative preparation example 1.

FIG. 4b shows the DSC thermograms of DHF-PPV and MDOF-PPV, as prepared in preparation examples 1 and 4.

FIG. 5 is a cross sectional view of an electroluminescent device, as prepared in example 2.

FIG. 6a shows the current-voltage (I-V) curves of DHF-PPV, copolymers (10: 1,1:1) of DHF-PPV and MEH-PPV, and MEH-PPV, in forward bias of the electroluminescent device as prepared in example 2.

FIG. 6b shows the current-voltage (I-V) curves of DHF-PPV and MDOF-PPV, in forward bias of the electroluminescent device as prepared in example 2.

FIG. 7 is the luminance-current (L-I) curve in forward bias of the electroluminescnet device as prepared in example 2.

### DETAILED DESCRIPTION OF THE INVENTION

Priority Korean Patent Application No.2000-65864 filed Nov. 7, 2000, entitled “Electroluminescent Polymer Having Fluorene Pendant and Electroluminescent Device Using the Same” is incorporated herein in its entirety by reference.

An electroluminescent polymer of the present invention comprises a main chain of poly(p-phenylene vinylene) (PPV) and a side chain of fluorene and a long chain aliphatic alkyl or alkoxy group introduced to a phenylene ring, which is represented by the following formula (1):

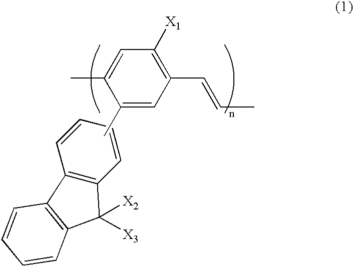

wherein X₁ is a linear alkyl or alkoxy group having 1 to 40 carbon atoms, a branched alkyl or alkoxy group having 3 to 40 carbon atoms, a cyclic alkyl group having 5 to 40 carbon atoms, or a silyl group substituted with at least one alkyl group having 1 to 40 carbon atoms, and X₂ and X3 are independently a hydrogen atom, a linear alkyl or alkoxy group having 1 to 40 carbon atoms, a branched alkyl or alkoxy group having 3 to 40 carbon atoms, a cyclic alkyl group having 5 to 40 carbon atoms, an aromatic group having 6 to 14 carbon atoms which is unsubstituted or substituted with at least one selected from the group consisting of an alkoxy group having 1 to 40 carbon atoms and an amine group, a silyl group substituted with at least one alkyl group having 1 to 40 carbon atoms, or —{(CH₂)ₓO}_{y}CH₃ wherein x is an integer from 1 to 10 and y is an integer from 1 to 10. Examples of the cyclic aliphatic group include cyclohexyl group, admantyl group, etc. Examples of the silyl group include trimethylsilyl group, dimethyloctylsilyl group, etc. Examples of the aromatic group phenyl group, naphthyl group, etc.

The electroluminescent polymer is preferably synthesized by Gilch polymerization through dehydrohalogenation and 1,6-addition elimination of fluorene-containing 1,4-bisbromomethyl-fluorenyl-benzene represented by the following formula (2), under alkali conditions, such as in a potassium t-butoxide environment:

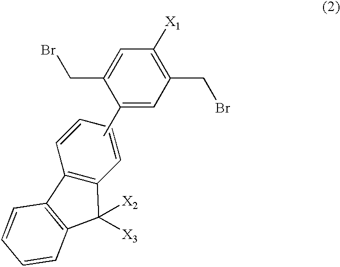

wherein, X₁, X₂ and X3 are defined as in the above formula (1).

The present electroluminescent polymer preferably has a number average molecular weight (Mn) of about 10,000-1,000,000 and a molecular weight distribution of about 1.5-5.0, realized by use of Gilch polymerization capable of obtaining high molecular weights, whereas conventional electroluminescent polymer synthesized by Wittig condensation has a molecular weight of about 10,000.

In the introduction of a substituent for increasing solubility, fluorene contributes to introduce an alkyl group and the like without a functional group containing a heteronuclear atom into it's 9,9′-carbon position, and thus the polymer can be designed to have excellent solubility because it comprises only carbon and hydrogen. In addition, fluorene, a large substituent, enhances the torsion effect and thus shortens the polymer's conjugated backbone length, so that the fluorene-containing polymer has a higher green purity than conventional PPV derivatives. Introduction of an alkoxy group and copolymerization with dialkoxy PPV (e.g., MEH-PPV or OC1C1O-PPV) result in improvement of charge injection performance by control of the color tuning and ionic energy level of the polymer.

Hence, a monomer of the present electroluminescent polymer can copolymerized with a conventional PPV-based monomer, to produce an electroluminescent polymer represented by the following formula (3):

[chemical structure]

wherein X₁, X₂ and X₃ are defined as in the above formula (1), X₄ and X₅ are independently a linear aliphatic alkoxy group having 1 to 40 carbon atoms, a branched aliphatic alkoxy group having 3 to 40 carbon atoms, or a cyclic aliphatic alkoxy group having 5 to 40 carbon atoms, and a and b are numbers such that 0.1 ≲a/(a+b)≲0.9.

Examples of the PPV-based monomer include, without limitation, 2,5-bis(bromomethyl)-4-(2′-ethylhexyloxy)anisole (M EH-PPV monomer) and 2,5-bis(bromomethyl)-3′, 7′-dimethyloctyloxy-4-methoxybenzene (OC1OC1O-PPV monomer).

In order to control the luminescence properties, the luminescent polymer of the present invention can be blended with a PPV-based luminescent polymer in the weight ratio of about 1:99-99:1. The PPV-based luminescent polymer is exemplified, without limitation, by MEH-PPV (poly(1-methoxy-4-(2′-ethylhexyloxy)-2,5-phenylene vinylene)), and OC1 C1O-PPV (poly(1-methoxy-4-(3′, 7′-dimethyloctyloxy)-2,5-phenylene vinylene)).

An electroluminescent device according to the invention preferably comprises an anode/light emitting layer/cathode structure, an anode/buffer layer/light emitting layer/cathode structure, an anode/buffer layer/hole transport layer/light emitting layer/cathode structure, an anode/buffer layer/hole transport layer/light emitting layer/electron transport layer/cathode structure, or an anode/buffer layer/hole transport layer/light emitting layer/hole blocking layer/cathode structure. Generally, a transparent ITO glass preferably is used as the anode. As the cathode, Al, Al:Li or Ca, which is low in work function efficiency, is preferably used. The electron transport layer and the hole transport layer are responsible for effectively transporting carriers to the light emitting layer, thereby increasing the combining probability in the luminescent polymer. The buffer layer preferably comprises a material selected from the group consisting of polythiophene, polyaniline, polyacetylene, polypyrrole, and polyphenylene vinylene derivatives. The hole blocking layer preferably comprises LiF or MgF₂.

A better understanding of the present invention may be obtained in light of the following examples which are set forth to illustrate, but are not to be construed to limit, the present invention.

### PREPARATION EXAMPLE 1

Synthesis of Poly[2-(9′, 9″-dihexylfluorene-2′-yl)-1,4-phenylene vinylenel (DHF-PPV)

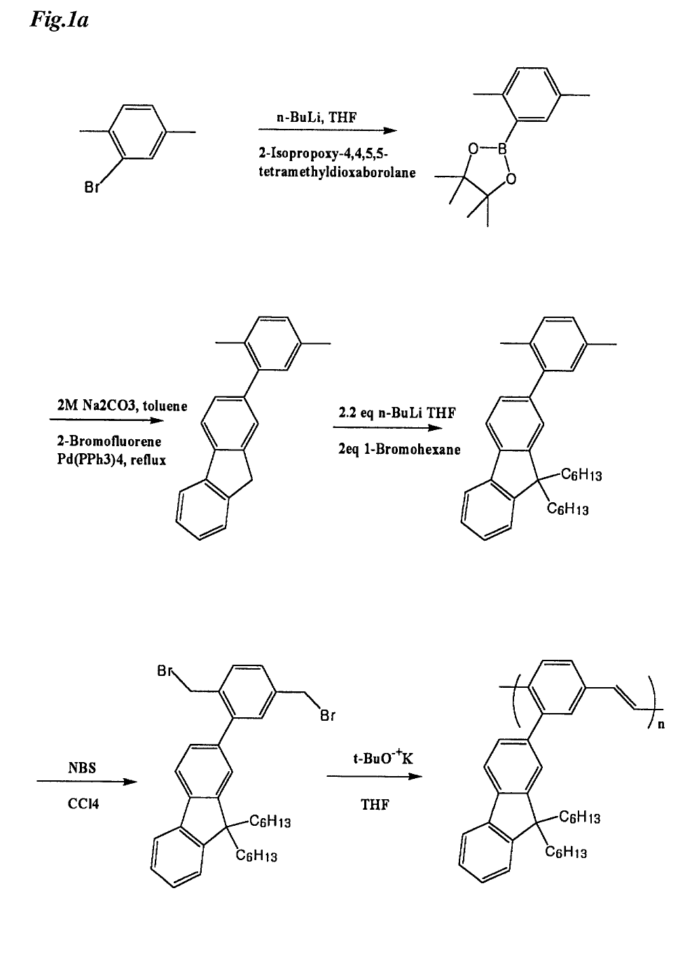

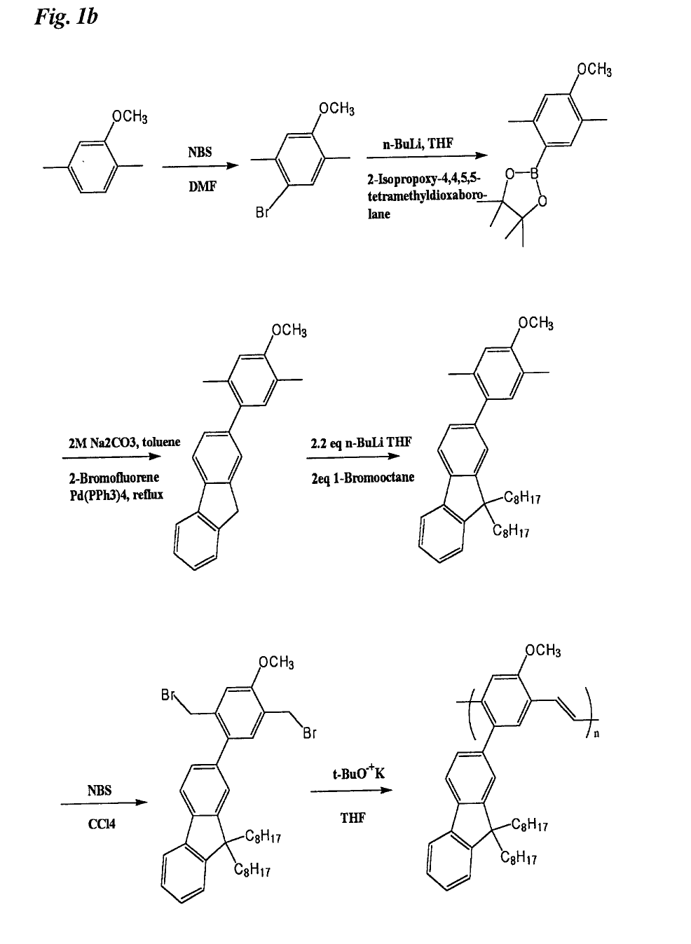

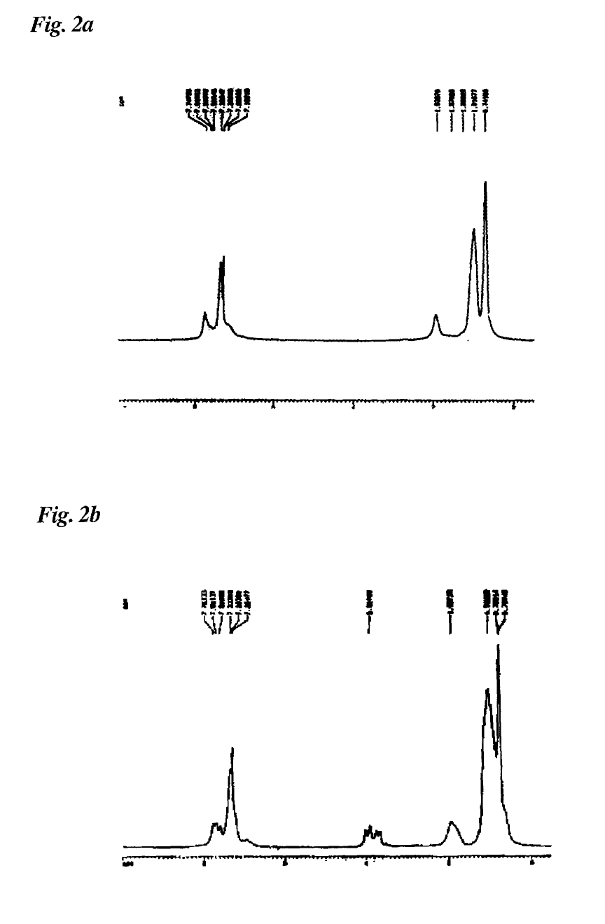

DHF-PPV was prepared in the following way, according to a reaction scheme as shown in FIG. 1a.

### (1) Synthesis of 2-(4′, 4′, 5′, 5′-tetramethyl-2′-isopropoxydioxaborolanyl)-p-xylene

In a three-neck flask, 10 g (54 mmol) of 2-bromoxylene was dissolved in 150 ml of THF under nitrogen atmosphere, and then 35.4 ml (1.05 eq) of n-butyllithium (1.6 M in hexane) was slowly added dropwise at −78° C. The reaction was left at the same temperature for 2 hours, then 13 ml (65 mmol, 1.2 eq) of 2-isopropoxy-4,4,5,5-tetramethyl-1,3,-dioxa-2-borolane was rapidly added at the same temperature. After the reaction was further carried out at room temperature for 24 hours, the reaction solution was washed with water. In the separated organic layer, the remaining water was removed with absolute MgSO₄. The solvent was removed by vacuum distillation, and the crude product was purified by column chromatography using a hexane developing solution, to obtain the title compound. Yield: 12 g (89%).

¹H-NMR (300 MHz, CDCl₃, ppm),δ7.6 (s,1H), 7.15 (d,1H), 7.1 (d,1H), 2.5 (s, 3H), 2.3 (s, 3H), 1.3 (s, 12H).

### (2) Synthesis of 2-(2′-fluorenyl)-p-xyiene

10 g (40 mmol) of 2-(4′,4′,5′,5′-tetramethyl-2′-isopropoxydioxaborolanyl)-p-xylene prepared in the above step (1), 8.2 g (33 mmol) of 2-bromofluorene and 2.3 g (2 mmol) of tetrakis(triphenylphosphine)palladium(0) were dissolved in 80 ml of toluene and 40 ml of 2 M Na₂CO₃, and then reacted at 100° C. for 48 hours. After the reaction was terminated by addition of 1 N HCl, the toluene layer was separated and filtered, and the remaining water was removed with absolute MgSO₄ and distilled under reduced pressure. The compound so obtained was purified by hexane/ethyl acetate (10/1, v/v) as a developing solution, to prepare the title compound as a white solid. M.p.: 106.5°C., yield: 7.3 g (82%).

¹H-NMR(300 MHz, CDCl₃, ppm), δ7.8(d, 2H), 7.6(d, 1H), 7.5(s, 1H), 7.3(m, 3H), 7.2(d, 1 H), 7.1 (m, 2H), 3.9(s, 3H), 2.4(s, 3H), 2.3(s, 3H).

### (3) Synthesis of 2-(2′-(9′,9″-dihexylfluorenvl))-p-xylene

Under a nitrogen atmosphere, 6 g (22 mmol) of 2-(2′-fluorenyl)-p-xylene prepared in the above step (2) was dissolved in 100 ml of THF (tetrahydrofuran), and 14.5 ml (1.05 eq) of n-butyllithium (1.6 M in hexane) was slowly added dropwise at −78° C. Thereafter, the reaction was left to stand at room temperature for 1 hour, then 3.1 ml of 1-bromohexane was added at 0° C. The reaction was further carried out at room temperature for 16 hours. The reaction was terminated by adding a saturated NH₄Cl solution to the reaction solution. The resulting solution was extracted with THF and the separated organic layer was dried over absolute MgSO₄, and distilled under reduced pressure, to remove the solvent.

The compound so obtained was repeatedly subjected to the above procedure, to prepare the title compound in an oil state. Yield: 7.9 g (82%).

¹H-NMR(300 MHz, CDCl₃, ppm), δ7.8(d, 2H), 7.3(m, 5H), 7.2(m, 3H), 2.4(s, 3H), 2.3(s, 3H), 2.0(m, 4H), 1.1 (m, 12H), 0.8(m, 10H).

### (4) Synthesis of 1,4-bisbromomethyl-2-(2′-(9′,9″-dihexVIfluorene)-2′-yl)benzene

6 g (13.7 mmol) of 2-(2″-(9′,9″-dihexylfluorenyl))-p-xylene prepared in the above step (3) and 5 g (28 mmol) of N-bromosuccinimide (NBS) were dissolved in 80 ml of CCl₄, and then, as an initiator, benzoyl peroxide was added in a catalytic amount thereto and refluxed for 3 hours.

After the reaction was terminated, the produced succinimide was filtered off and the obtained solution was distilled under reduced pressure, to remove the solvent. Finally, the crude product was purified by column chromatography using a hexane developing solution, to obtain the title compound as an oil. Yield: 3.5 g (43%).

¹H-NMR(300 MHz, CDCl₃, ppm), δ7.8(m, 2H), 7.5(m, 2H), 7.4(m, 6H), 4.5(s, 2H), 4.4(s, 2H), 2.0(m, 4H), 1.1 (m, 12H), 0.8(t, 6H), 0.7(m, 4H)

### (5) Synthesis of poly[2-(9′,9″-dihexylfluorene-2′-yl)-1,4-phenylene vinylenel (DHF-PPV)

Under nitrogen atmosphere, 0.5 g (0.84 mmol) of 1,4-bisbromomethyl-2-(2′-(9′,9″-dihexylfluorene)-2-yl)benzene prepared in the above step (4) was dissolved in 50 ml of absolute THF, together with 2 mg (0.1 eq) of t-butylbenzyl bromide, and then cooled to 0°C. As an initiator, 2.5 ml (3 eq) of potassium t-butoxide (1 M in THF) was slowly introduced into the solution over 20 minutes. The reaction was left to stand at 0° C. for 3 hours. After completion of the reaction, the solution was added with 200 ml of methanol to yield yellow precipitates, which were then washed with hot methanol using a Soxhlet extractor for 1 day, to remove impurities and compounds having low molecular weights. The product so obtained was extracted with CHCl₃ and precipitates in methanol were produced and dried, to prepare the title polymer having high molecular weight.

¹H-NMR(300 MHz, CDCl₃, ppm): δ7.7(s, 4H), 7.4(s, 6H), 7.2(s, 2H), 1.9(s, 4H), 1.0(s,18H), 0.7(s, 4H)

### COMPARATIVE PREPARATION EXAMPLE 1

### Preparation Of MEH-PPV

2,5-bis(bromomethyl)-4-(2′-ethylhexyloxy)anisole was homopolymerized in the same manner as in the step (5) of the above example 1, to produce MEH-PPV polymer.

### PREPARATION EXAMPLE 2

### Synthesis of Poly[2-(9′,9″-dihexylfluorene-2′-yl)-1.4-phenylene vinylene]-co-[(1 -methoxy-4-(2′-ethylhexyloxy)-2,5-phenylene vinylene)](DHF-PPV:MEH-PPV =1 :1) Random Copolymer

Under a nitrogen atmosphere, 0.2 g (0.335 mmol) of 1,4-bisbromomethyl-2-(2′-(9′,9″-dihexylfluorene-2′-yl))benzene prepared in the above preparation example 1-(4), 2,5-bis(bromomethyl)-4-(2′-ethylhexyloxy)anisole (0.113 g, 0.335 mmol) as a monomer of MEH-PPV and 1.6 mg (0.1 eq) of t-butylbenzyl bromide were dissolved in 30 ml of THF and then cooled to 0° C. As an initiator, 1.6 ml of potassium t-butoxide (1 M in THF) was slowly introduced into the solution. Then, the reaction was left to stand at 0° C. for 3 hours. After completion of the reaction, the reaction solution was combined with methanol to yield orange precipitates, which were then washed with hot methanol using a Soxhlet extractor for 1 day, to remove impurities and compounds having low molecular weights. The product so obtained was extracted with CHCl₃ and precipitates in methanol were produced and dried, to prepare the title polymer having high molecular weight.

### PREPARATION EXAMPLE 3

### Synthesis of Poly[2-(9′,9″-dihexylfluorene-2′-yl)-1,4-phenylene vinylenel-co-[1-methoxy-4-(2′-ethylhexyloxy)-2,5-phenylene vinylene](DHF-PPV:MEH-PPV=10:1) Random Copolymer

Under a nitrogen atmosphere, 0.3 g (0.503 mmol) of 1,4-bisbromomethyl-2-(2′-(9′,9″-dihexylfluorene-2′-yl))benzene prepared in the above preparation example 1-(4) and 0.017 g (0.05 mmol) of 2,5-bis(bromomethyl)-4-(2′-ethylhexyloxy)anisole as a monomer of MEH-PPV were dissolved in 30 ml of purified THF, along with 1.2 mg (0.1 eq) of t-butylbenzyl bromide, and then cooled to 0° C. As an initiator, 1.3 ml of potassium t-butoxide (1 M in THF) was slowly introduced into the solution. Then, the reaction was left at 0° C. for 3 hours. The reaction solution was combined with methanol to yield orange precipitates, which were then washed with hot methanol using a Soxhlet extractor for 1 day, to remove impurities and compounds having low molecular weights. The product so obtained was extracted with CHCl₃ and precipitates in methanol were produced and dried, to prepare the title polymer having high molecular weight.

### PREPARATION EXAMPLE 4

### Synthesis of Poly[2-methoxy-5-(9′,9″-dioctylfluorene-2′-yl)-1,4-phenylene vinylenel (MDOF-PPV)

MDOF-PPV was prepared in the following way, according to a reaction scheme as shown in FIG. 1b.

### (1) Synthesis of 1 -bromo-4-methoxy-2,5-dimethylbenzene

To 30.0 g (220 mmol) of 2,5-dimethylanisole in 160 ml of DMF, 43.1 g (242 mmol) of N-bromosuccinimide (NBS) in 50 ml of DMF was slowly added at 0° C. The reaction was performed at room temperature for 24 hours. After completion of the reaction, the reaction solution was washed with water and CHCl₃. In the separated organic layer, the remaining water was removed with absolute MgSO₄. The filtered organic layer was distilled under reduced pressure and the solvent was separated and dried, to prepare the title compound in a white solid state. M.p.: 38.4 ° C., yield: 45.0 g (95.1%).

¹H-NMR(300 Mhz, CDCl₃, ppm), δ7.3(s,1H), 6.7(s,1H), 3.8(s, 3H), 2.4(s, 3H), 2.2(s, 3H).

### (2) Synthesis of 1 -methoxy-4-(4′,4′,5′,5′-tetramethyl-2′-isopropoxydioxaboranyl)-2,5-dimethylbenzene

20 g (93 mmol) of 1 -bromo-4-methoxy-2,5-dimethylbenzene synthesized in the above step (1) was dissolved in 150 ml of THF, and 41.9 ml (1.05 eq) of n-butyllithium (1.6 M in hexane) was slowly added thereto at −78° C. The reaction was left to stand at the same temperature for 2 hours. Then, 1.5 equivalents of 2-isopropoxy-4,4,5,5-tetramethyl-1,3-dioxa-2-borolane was rapidly introduced to the reaction solution at −78°C. and the reaction was further performed at room temperature for 24 hours. After the reaction was terminated with 150 ml of water, the organic layer was extracted, washed with water 3 times, separated and dried over absolute MgSO₄. The solvent was distilled off under reduced pressure. The solid compound so obtained was recrystallized with methanol. M.p.: 154.0° C., yield: 19.7 g (76%).

¹H-NMR(300 Mhz, CDCl₃, ppm) δ7.5(s, 1H), 6.6(s,1H), 3.8(s, 3H), 2.5(s, 3H), 2.2(s, 3H), 1.3(s, 12H)

### (3) Synthesis of 1 -methoxy-4-(fluorene-2′-yl)-2,5-dimethylbenzene

15 g (54 mmol) of 1 -methoxy-4-(4′,4′,5′,5′-tetramethyl-2′-isopropoxydioxaboranyl)-2,5-dimethylbenzene synthesized in the above step (2), together with 11 g (45 mmol, 0.83 eq) of 2-bromofluorene and 2.6 g (2.25 mmol) of tetrakis(triphenylphosphine)palladium(0) was dissolved in 120 ml of toluene and 60 ml of 2 M Na₂CO₃, and reacted at 100° C. for 48 hours. The reaction was terminated with 1 N HCl solution, and the organic layer was extracted with toluene and separated. The extracted organic layer was dried over absolute MgSO₄, filtered and distilled under reduced pressure, to remove the solvent. The compound so prepared was a white solid. M.p.: 157.9° C., yield: 13.3 g (82%).

¹H-NMR(300 Mhz, CDCl₃, ppm) δ7.8(d, 2H), 7.5(d, 1H), 7.4(s, 1H) 7.3(m, 3H) 7.1 (s,1H), 6.8(s,1H), 3.97(s, 2H), 3.91 (s, 3H), 2.3(s, 3H), 2.2(s, 3H)

### (4) Synthesis of 1 -methoxy-4-(9′,9″-dioctylfluorene-2′-yl)-2,5-dimethylbenzene

Under a nitrogen atmosphere, 10 g (33.3 mmol) of 1 -methoxy-4-(fluorene-2′-yl)-2,5-dimethylbenzene prepared in the above step (3) was dissolved in 100 ml of THF, and 21.8 ml (35 mmol, 1.05 eq) of n-butyllithium (1.6 M in hexane) was slowly added at −78° C. The reaction was left at the same temperature for 2 hours, and then 6.43 g (1 eq) of 1 -bromooctane was added at 0° C. The reaction was continued for 16 hours and then terminated with saturated NH₄Cl solution. The organic layer was separated with THF and washed with water 3 times. The organic layer was separated again and dried over absolute MgSO₄ and filtered, and the solvent was removed by vacuum distillation, to produce the title compound as an oil. Yield: 14.3 g (82%).

¹H-NMR(300 MHz, CDC1₃, ppm), δ7.7(d, 2H), 7.3(m, 5H), 7.1(s, 1H), 6.7(s, 1H), 3.9(s, 3H), 2.3(s, 3H), 2.2(s, 3H), 1.9(t, 4H), 1.1 (m, 20H), 0.8(t, 6H), 0.7(m, 4H)

### (5) Synthesis of 1,4-bisbromomethyl-2-methoxy-5-(9′,9″-dioctylfluorene-2′-yl)benzene

10 g (19 mmol) of 1 -methoxy-4-(9′,9″-dioctylfluorene-2′-yl)-2,5-dimethylbenzene synthesized in the above step (4) and 7.1 g of N-bromosuccinimide (NBS) were dissolved in 150 ml of CC14, and then benzoyl peroxide was added in a catalytic amount and refluxed for 3 hours. After completion of the reaction, the reaction solution was filtered and the filtered solution was distilled under reduced pressure, to remove the solvent. The compound so obtained, in an oil state, was purified by column chromatography using hexane as a developing solution. Yield: 5.4 g (42%).

¹H-NMR(300 MHz, CDCl₃, ppm), δ7.7(m, 2H), 7.5(s, 1H), 7.3(m, 5H), 7.0(s, 1H), 4.6(s, 2H), 4.4(s, 2H), 4.0(s, 3H), 2.0(m, 4H), 1.1 (m, 20H), 0.8(t, 6H), 0.7(m, 4H)

### (6) Polymerization of poly[2-methoxy-5-(9′,9″-dioctylfluorene-2′-yl)-1,4-phenylene vinylenel (MDOF-PPV)

Under a nitrogen atmosphere, 0.5 g (0.73 mmol) of 1 ,4-bisbromomethyl-2-methoxy-5-(9′,9″-dioctylfluorene-2′-yl)benzene synthesized in the above step (5) was dissolved in 50 ml of THF, and 16.6 mg (0.1 eq) of t-butylbenzyl bromide was added thereto and then cooled to 0° C. As an initiator, 2.2 ml (3 eq) of potassium t-butoxide (1 M in THF) was slowly introduced into the solution. The polymerization reaction was performed for 3 hours. After completion of the reaction, the solution was combined with 200 ml of methanol to yield yellow precipitates, which were then washed with hot methanol using a Soxhlet extractor for 1 day, to remove impurities and compounds having low molecular weights. The polymer so obtained was extracted with CHCl₃ again and precipitates in methanol were produced and dried, to prepare the title polymer having high molecular weight.

¹H-NMR(300 MHz, CDCl₃, ppm): δ7.7(m, 4H), 7.3(s, 5H), 7.2(s, 2H), 3.9(m, 3H), 1.9(s, 4H), 1.0(s, 26H), 0.7(s, 4H)

### EXAMPLE 1

### Measurement of Physical Properties of Luminescent Polymer

### 1) Optical Properties

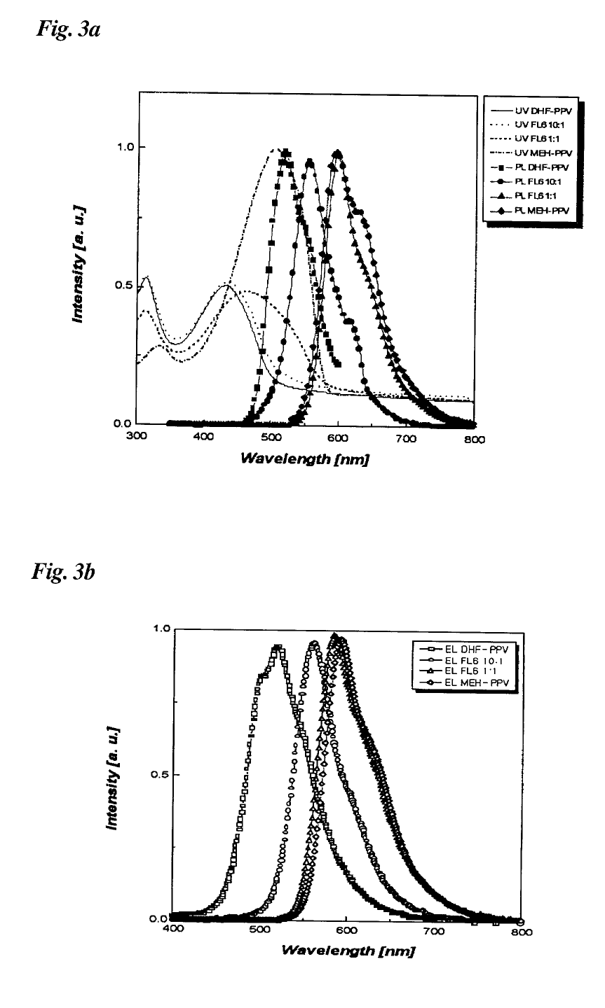

The luminescent polymers synthesized in the preparation examples 1-4 and the comparative example 1 were dissolved in chlorobenzene and then spin-coated on a quartz plate to form polymeric membranes, which were measured for UV absorption peaks and PL (photoluminescence) spectrum. The results are shown in FIG. 3a. UV absorption peaks were 432 nm for DHF-PPV, 435 nm for DHF-PPV:MEH-PPV (10:1), 463 nm for DHF-PPV:MEH-PPV (1:1), and 504 nm for MEH-PPV. PL maximum peaks were 517 nm, 553 nm, 585 nm, and 596 nm for the above polymers.

### 2) Thermal Properties

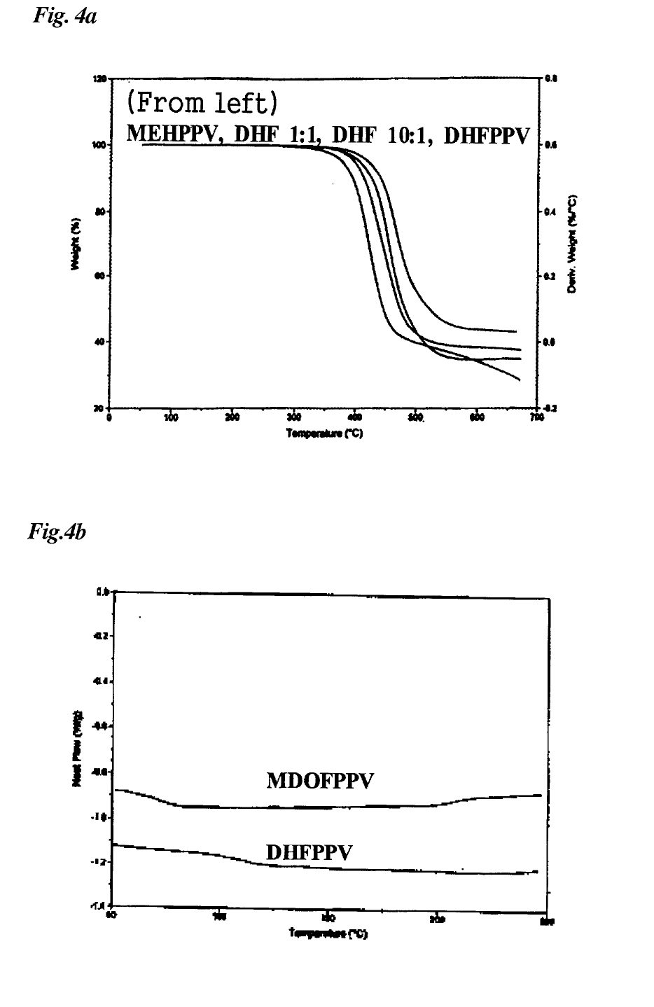

Using TGA (thermogravimetric analysis) and DSC (differential scanning calorimetry), the thermal properties of polymers were measured under nitrogen atmosphere at a rate of 10° C./min. The results are given in FIGS. 4a and 4b. In the TGA thermogram, temperatures at which 5% weight loss occurred were 429° C. for DHF-PPV, 405° C. for DHF-PPV:MEH-PPV (10:1), 403° C. for DHF-PPV:MEH-PPV (1:1),423° C. for MDOF-PPV and 377° C. for MEH-PPV. From the results, it can be seen that thermal stability is decreased as the amount of heteronuclear atoms becomes larger. The glass transition temperatures (Tg) of DHF-PPV and MDOF-PPV, measured by DSC thermogram, were 114° C. and 74° C., respectively.

### EXAMPLE 2

### Fabrication Of Electroluminescent Device

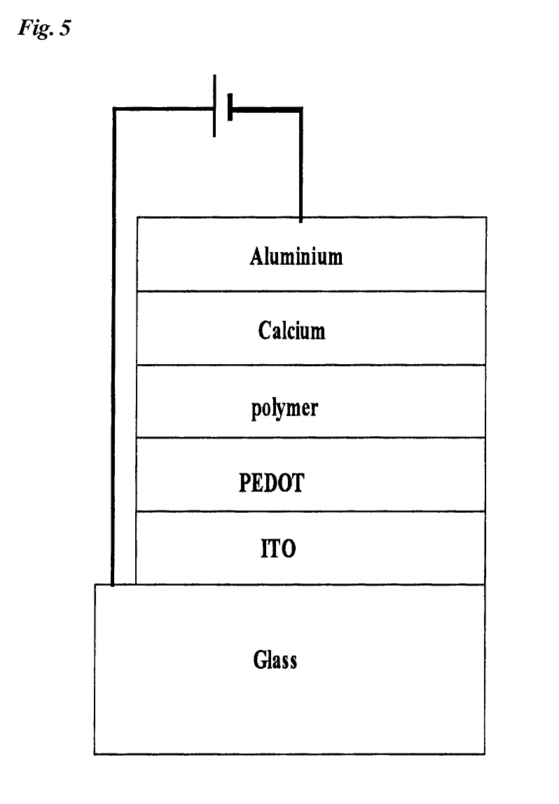

Using the polymers prepared in the preparation examples 1-4 and the comparative preparation example 1, electroluminescent devices were fabricated according to the following procedure. A transparent electrode substrate comprising ITO (indium-tin oxide) coated onto a glass substrate was subjected to ultrasonication in acetone for 20 min., then IPA (isopropyl alcohol) for 20 min., and then washed with boiling IPA. Thereafter, PEDOT was spin-coated to a thickness of 25 nm thereon and dried. Next, 0.5% by weight of each of polymers prepared in the preparation examples 1-4 and the comparative preparation example 1 was dissolved in chlorobenzene and then spin-coated on the PEDOT layer to a thickness of 80 nm. The rotation rate of the substrate was 2200 rpm and the period of time required for rotation was 50 seconds. The spin-coated substrate was dried at 80° C. for 1 hour on a hot-plate. On the substrate, calcium as a cathode was deposited to a thickness of 50 nm and then an aluminum layer 200 nm thick was deposited on the calcium layer, thus preparing a final device shown in FIG. 5.

The devices so fabricated [ITO/PEDOT/polymer/Ca/AI] were measured for their electrical and electroluminescent properties, by driving direct voltage as forward bias voltage on a light emitting area of 2 mm².

A maximum wavelength of the emitted light was 520 nm of green light for DHF-PPV, 561 nm of yellow light for a random copolymer of DHF and MEH-PPV (10:1), 585 nm of orange-red light for a random copolymer of DHF and MEH-PPV (1:1) and 532 nm of yellow light for MDOF-PPV. Ionic energy affecting hole-injection, which determines the performance of the device, was 6.0 eV for DHF-PPV, 5.7 eV for DHF-PPV:MEH-PPV (10:1), 5.4 eV for DHF-PPV:MEH-PPV (1:1) and 5.6 eV for MDOF-PPV, compared to 4.8 eV for ITO. This means that copolymerization and introduction of alkoxy groups result in an increase in the ionic energy, thereby improving the performance of the device. In TGA, the synthesized polymers were decomposed at lower temperatures as the amount of oxygen, a heteronuclear atom, was increased. So, it can be seen that the thermal stability of the polymers having heteronuclear atoms is reduced.

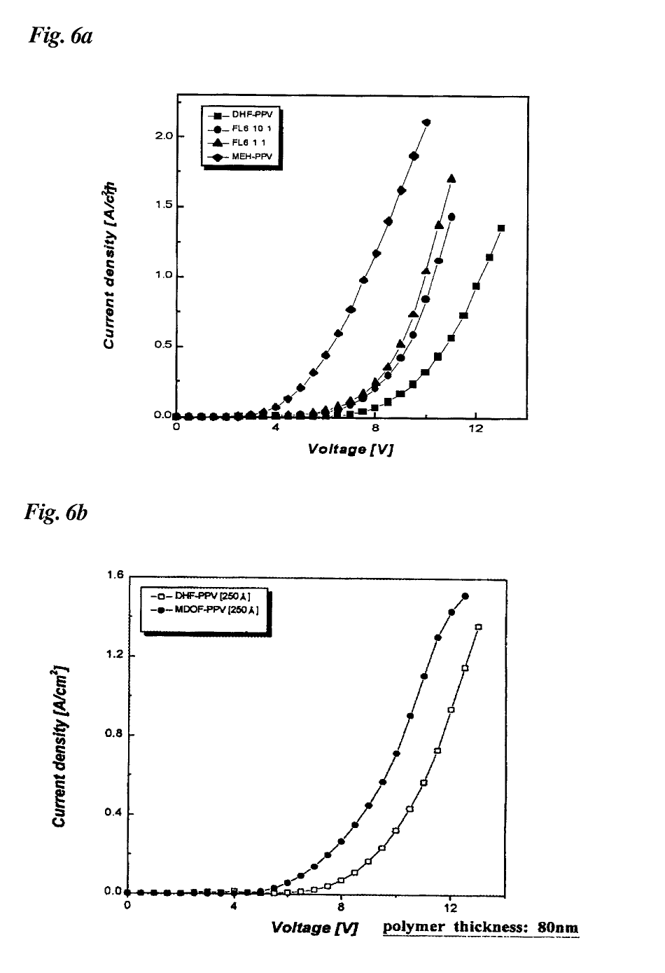

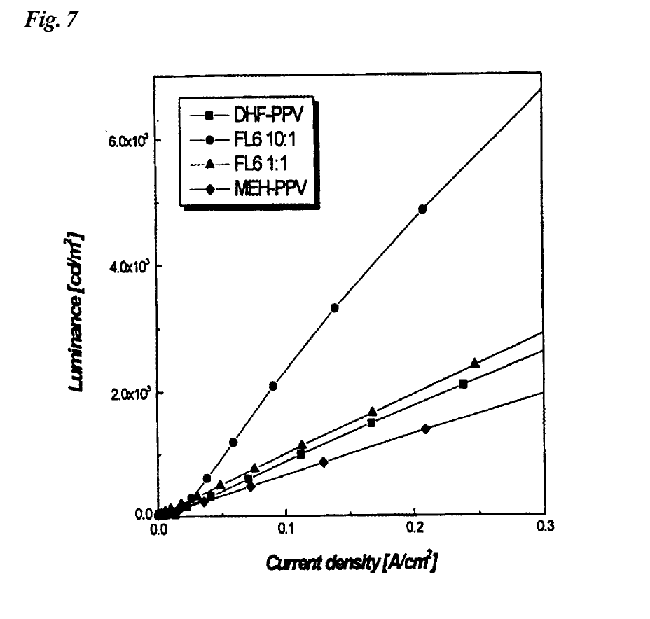

From the current-voltage curves shown in FIGS. 6a and 6b, it can be confirmed that the larger the MEH-PPV content, the more smoothly the current relative to voltage flows. In the current properties relative to luminance as shown in FIG. 7, MEH-PPV was the lowest in luminance strength versus current, and DHF-PPV, DHF-PPV:MEH-PPV (1:1) and DHF-PPV:MEH-PPV (10:1), in due order, were increased. Particularly, in the case of DHF-PPV:MEH-PPV (10:1), the luminance strength was drastically raised. The flow of current was smooth in the presence of larger amounts of MEH-PPV, whereas the current did not smoothly flow under DHF-PPV, even though DHF-PPV had more excellent luminance efficiency versus current than that of MEH-PPV. However, it can be found that the above problems are lessened, in the case of copolymer, that is, DHF-PPV:MEH-PPV (10:1) and DHF-PPV:MEH-PPV (1:1). This shows that the copolymer having an optimum copolymerization ratio can have excellent luminous efficiency. Hence, by copolymerizing the polymer of the present invention with a conventional PPV-based derivative, in particular, a dialkoxy-based PPV derivative, color tuning as well as luminous efficiency can be increased. As for MDOF-PPV comprising a methoxy group introduced to DHF-PPV, the ionic energy was decreased 5.6 eV by the methoxy group, compared to 6.0 eV for DHF-PPV, and thus resistance for hole-injection from the ITO anode was reduced and the flow of current became smooth, attributable to the electron donating effect of the alkoxy groups. MDOF-PPV has excellent, as is DHF-PPV.

As described above, the polymers of the present invention, having a structure that increases solubility without a heteronuclear atom, as fluorene-substituted PPV derivatives, have advantages in that, due to their higher thermal stability, performance deterioration, such as lifetime reduction of the device by generated heat, can be prevented. Furthermore, the torsion effect is enhanced by introduction of fluorene, whereby the polymer can have higher green purity. Additionally, because of introduction of alkoxy groups and copolymerization with dialkoxy PPV, the color tuning and ionic energy of the polymer can be controlled and thus charge-injection performance becomes better, thereby increasing luminous efficiency.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. An electroluminescent polymer, represented by the following formula (1): 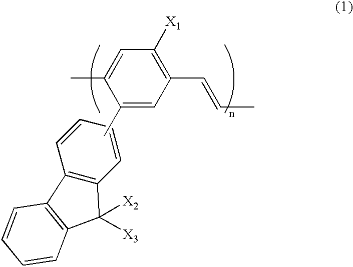
wherein
X₁ is a linear alkyl or alkoxy group having 1 to 40 carbon atoms, a branched alkyl or alkoxy group having 3 to 40 carbon atoms, a cyclic alkyl group having 5 to 40 carbon atoms, or a silyl group substituted with at least one alkyl group having 1 to 40 carbon atoms, and
X₂ and )(3are independently a hydrogen atom, a linear alkyl or alkoxy group having 1 to 40 carbon atoms, a branched alkyl or alkoxy group having 3 to 40 carbon atoms, a cyclic alkyl group having 5 to 40 carbon atoms, an aromatic group having 6 to 14 carbon atoms which is unsubstituted or substituted with at least one selected from the group consisting of an alkoxy group having 1 to 40 carbon atoms and an amine group, a silyl group substituted with at least one alkyl group having 1 to 40 carbon atoms, or −{(CH₂)ₓO}_{y}CH₃ wherein x is an integer from 1 to 10 and y is an integer from 1 to 10.

2. The electroluminescent polymer as defined in claim 1, wherein the number average molecular weight of the electroluminescent polymer is about 10,000-1,000,000 and the molecular weight distribution thereof is about 1.5-5.0.

3. An electroluminescent polymer, comprising (a) a PPV-based monomer substituted with a fluorene and an aliphatic alkyl or alkoxy group, and (b) a PPV-based monomer, the electroluminescent polymer represented by the following formula (3): [chemical structure]
wherein
X₁ is a linear alkyl or alkoxy group having 1 to 40 carbon atoms, a branched alkyl or alkoxy group having 3 to 40 carbon atoms, a cyclic alkyl group having 5 to 40 carbon atoms, or a silyl group substituted with at least one alkyl group having 1 to 40 carbon atoms,
X₂ and X₃ are independently a hydrogen atom, a linear alkyl or alkoxy group having 1 to 40 carbon atoms, a branched alkyl or alkoxy group having 3 to 40 carbon atoms, a cyclic alkyl group having 5 to 40 carbon atoms, an aromatic group having 6 to 14 carbon atoms which is unsubstituted or substituted with at least one selected from the group consisting of an alkoxy group having 1 to 40 carbon atoms and an amine group, a silyl group substituted with at least one alkyl group having 1 to 40 carbon atoms, or −{(CH₂)ₓO}_{y}CH₃ wherein x is an integer from 1 to 10 and y is an integer from 1 to 10,
X4 and X5 are independently a linear aliphatic alkoxy group having 1 to 40 carbon atoms, a branched aliphatic alkoxy group having 3 to 40 carbon atoms, or a cyclic aliphatic alkoxy group having 5 to 40 carbon atoms, and
a and b are numbers such that 0.1 ≲<a/(a+b)<0.9.

4. The electroluminescent polymer as defined in claim 3, wherein the number average molecular weight of the electroluminescent polymer is about 1 0,000-1,000,000 and the molecular weight distribution thereof is about 1.5-5.0.

5. The electroluminescent polymer as defined in claim 3, wherein the monomer (b) is selected from the group consisting of 2,5-bis(bromomethyl)-4-(2′-ethylhexyloxy)anisole and 2,5-bis(bromomethyl)-3′,7′-dimethyloctyloxy-4-methoxybenzene.

6. An electroluminescent polymer composition comprising
(a) an electroluminescent polymer, represented by the following formula (1):
formula (1): 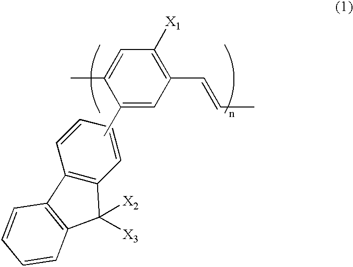
wherein
X₁ is a linear alkyl or alkoxy group having 1 to 40 carbon atoms, a branched alkyl or alkoxy group having 3 to 40 carbon atoms, a cyclic alkyl group having 5 to 40 carbon atoms, or a silyl group substituted with at least one alkyl group having 1 to 40 carbon atoms, and
X₂ and X3 are independently a hydrogen atom, a linear alkyl or alkoxy group having 1 to 40 carbon atoms, a branched alkyl or alkoxy group having 3 to 40 carbon atoms, a cyclic alkyl group having 5 to 40 carbon atoms, an aromatic group having 6 to 14 carbon atoms which is unsubstituted or substituted with at least one selected from the group consisting of an alkoxy group having 1 to 40 carbon atoms and an amine group, a silyl group substituted with at least one alkyl group having 1 to 40 carbon atoms, or —{(CH₂)ₓO}CH₃ wherein x is an integer from 1 to 10 and y is an integer from 1 to 10, and
(b) a PPV-based polymer,
wherein the electroluminescent polymer (a) and the PPV-based polymer (b) are mixed in a weight ratio of about 1:99-99:1.

7. The electroluminescent polymer composition as defined in claim 6, wherein the PPV-based polymer (b) is selected from the group consisting of poly(1 -methoxy-4-(2′-ethylhexyloxy)-2,5-phenylene vinylene) and poly(1 -methoxy-4-(3′,7′-dimethyloctyloxy)-2,5-phenylene vinylene).

8. An electroluminescent device having a structure selected from the group consisting of an anode/light emitting layer/cathode, an anode/buffer layer/light emitting layer/cathode, an anode/buffer layer/hole transport layer/light emitting layer/cathode, an anode/buffer layer/hole transport layer/light emitting layer/electron transport layer/cathode, and an anode/buffer layer/hole transport layer/light emitting layer/hole blocking layer/cathode, wherein the light emitting layer comprises an electroluminescent polymer of claim 1.

9. The device as defined in claim 8, wherein the buffer layer comprises a material selected from the group consisting of polythiophene, polyaniline, polyacetylene, polypyrrole and polyphenylene vinylene derivatives.

10. The device as defined in claim 8, wherein the hole blocking layer comprises LiF or MgF₂.

11. An electroluminescent device having a structure selected from the group consisting of an anode/light emitting layer/cathode, an anode/buffer layer/light emitting layer/cathode, an anode/buffer layer/hole transport layer/light emitting layer/cathode, an anode/buffer layer/hole transport layer/light emitting layer/electron transport layer/cathode, and an anode/buffer layer/hole transport layer/light emitting layer/hole blocking layer/cathode, wherein the light-emitting layer comprises an electroluminescent polymer of claim 3.

12. The device as defined in claim 1 1, wherein the buffer layer comprises a material selected from the group consisting of polythiophene, polyaniline, polyacetylene, polypyrrole and polyphenylene vinylene derivatives.

13. The device as defined in claim 11, wherein the hole blocking layer comprises LiF or MgF₂.

14. An electroluminescent device having a structure selected from the group consisting of an anode/light emitting layer/cathode, an anode/buffer layer/light emitting layer/cathode, an anode/buffer layer/hole transport layer/light emitting layer/cathode, an anode/buffer layer/hole transport layer/light emitting layer/electron transport layer/cathode, and an anode/buffer layer/hole transport layer/light emitting layer/hole blocking layer/cathode, wherein the light-emitting layer comprises an electroluminescent polymer composition of claim 6.

15. The device as defined in claim 14, wherein the buffer layer comprises a material selected from the group consisting of polythiophene, polyaniline, polyacetylene, polypyrrole and polyphenylene vinylene derivatives.

16. The device as defined in claim 14, wherein the hole blocking layer comprises LiF or MgF₂.

17. A method of producing an electroluminescent polymer, represented by the following formula (1): 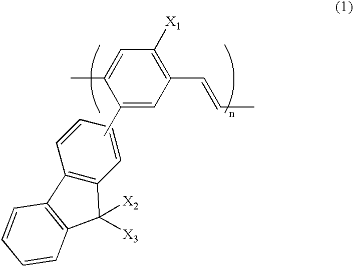
wherein
X₁ is a linear alkyl or alkoxy group having 1 to 40 carbon atoms, a branched alkyl or alkoxy group having 3 to 40 carbon atoms, a cyclic alkyl group having 5 to 40 carbon atoms, or a silyl group substituted with at least one alkyl group having 1 to 40 carbon atoms, and
X₂ and X₃ are independently a hydrogen atom, a linear alkyl or alkoxy group having 1 to 40 carbon atoms, a branched alkyl or alkoxy group having 3 to 40 carbon atoms, a cyclic alkyl group having 5 to 40 carbon atoms, an aromatic group having 6 to 14 carbon atoms which is unsubstituted or substituted with at least one selected from the group consisting of an alkoxy group having 1 to 40 carbon atoms and an amine group, a silyl group substituted with at least one alkyl group having 1 to 40 carbon atoms, or −{(CH₂)ₓO}_{y}CH₃ wherein x is an integer from 1 to 10 and y is an integer from 1 to 10,
the method comprising the steps of dehydrohalogenation and 1,6-addition elimination of a fluorene-containing 1 ,4-bisbromomethyl-fluorenyl-benzene represented by the following formula (2), under alkali conditions: 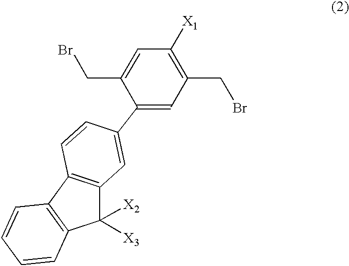
wherein X₁ , X₂ and X3 are defined as in the above formula (1).

18. A method of producing an electroluminescent copolymer represented by the following formula (3): 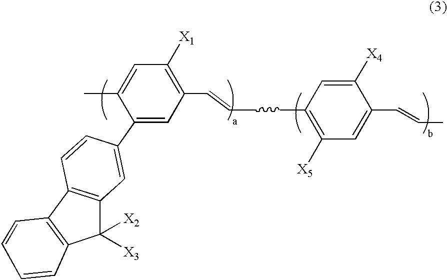
wherein
X₁ is a linear alkyl or alkoxy group having 1 to 40 carbon atoms, a branched alkyl or alkoxy group having 3 to 40 carbon atoms, a cyclic alkyl group having 5 to 40 carbon atoms, or a silyl group substituted with at least one alkyl group having 1 to 40 carbon atoms, and
X₂ and X₃ are independently a hydrogen atom, a linear alkyl or alkoxy group having 1 to 40 carbon atoms, a branched alkyl or alkoxy group having 3 to 40 carbon atoms, a cyclic alkyl group having 5 to 40 carbon atoms, an aromatic group having 6 to 14 carbon atoms which is unsubstituted or substituted with at least one selected from the group consisting of an alkoxy group having 1 to 40 carbon atoms and an amine group, a silyl group substituted with at least one alkyl group having 1 to 40 carbon atoms, or −(CH₂)ₓO}_{y}CH₃ wherein x is an integer from 1 to 10 and y is an integer from 1 to 10,
X₄ and X₅ are independently a linear aliphatic alkoxy group having 1 to 40 carbon atoms, a branched aliphatic alkoxy group having 3 to 40 carbon atoms, or a cyclic aliphatic alkoxy group having 5 to 40 carbon atoms, and
a and b are numbers such that 0.1≦a/(a+b)≦0.9,
the method comprising the step of copolymerizing (a) a monomer unit of an electroluminescent polymer represented by the following formula formula (1): 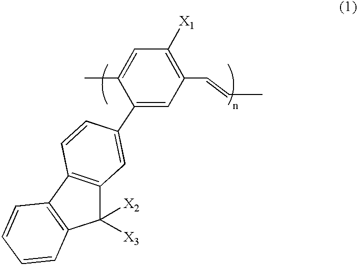
wherein
X₁ is a linear alkyl or alkoxy group having 1 to 40 carbon atoms, a branched alkyl or alkoxy group having 3 to 40 carbon atoms, a cyclic alkyl group having 5 to 40 carbon atoms, or a silyl group substituted with at least one alkyl group having 1 to 40 carbon atoms, and
X₂ and X₃are independently a hydrogen atom, a linear alkyl or alkoxy group having 1 to 40 carbon atoms, a branched alkyl or alkoxy group having 3 to 40 carbon atoms, a cyclic alkyl group having 5 to 40 carbon atoms, an aromatic group having 6 to 14 carbon atoms which is unsubstituted or substituted with at least one selected from the group consisting of an alkoxy group having 1 to 40 carbon atoms and an amine group, a silyl group substituted with at least one alkyl group having 1 to 40 carbon atoms, or −{(CH₂)ₓO}_{y}CH₃ wherein x is an integer from 1 to 10 and y is an integer from 1 to 1 0, with (b) a PPV-based polymer.
